(19) United States
(12) Patent Application Publication
(10) Pub. No.: US 2004/0032403 A1
(43) Pub. Date: Feb. 19, 2004

(54) Driving method for flat-panel display devices

(75) Inventors: Leonardo Sala, Pont Saint Martin (IT); Daniele Domanin, Aosta (IT); Roberto Gariboldi, Lacchiarella (IT)

Correspondence Address: Bryan A. Santarelli, GRAYBEAL JACKSON HALEY LLP, Suite 350, 155-108th Avenue NE, Bellevue, WA, 98004-5973, US

(73) Assignee: STMicroelectronics S.r.I. and DORA S.p.A.

(21) Appl. No.: 10/445,137

(22) Filed: May 23, 2003

(30) Foreign Application Priority Data
May 23, 2002 (EP) 02425326.2

(51) Int. Cl. G09G 5/00

(52) U.S. Cl. 345/204

(57) ABSTRACT

The present invention relates to a driving method for flat panel display devices, particularly a driving method combining a Multi Line Addressing (MLA) technique and a Frame Rate Control (FRC) technique, for flat panel display devices such as Liquid Crystal Display (LCD).

In an embodiment the method of driving an image display device comprises the following steps: dividing row electrodes of an image device, having a plurality of row electrodes and a plurality of column electrodes, into a plurality of subgroups; selecting one of the plurality of said subgroups having a prefixed number of electrodes; performing a gray scale display by a frame rate control (FRC) by using a prefixed number of frames and a prefixed number of bits representing the gray levels; decomposing one of said frame in a number of time instants proportional to said prefixed number of electrodes; putting the bits representing the gray levels equally distributed in said prefixed number of frames.

### PRIORITY CLAIM

This application claims priority from European patent application No. 02425326.2, filed May 23, 2002, which is incorporated herein by reference.

### TECHNICAL FIELD

The present invention relates generally to a driving method for flat panel display devices, particularly a driving method combining a Multi Line Addressing (MLA) technique and a Frame Rate Control (FRC) technique, for flat panel display devices such as Liquid Crystal Display (LCD).

### BACKGROUND

It is known that, any flat panel display, such as an LCD, includes an array of picture elements (pixel) arranged as a rectangular matrix. In a matrix LCD the row and column electrodes are perpendicular to each other. Area of intersection of the row and column electrode defines a pixel. A row electrode and a column electrode uniquely address a pixel as shown in FIG. 1.

FIG. 1 is a schematic block diagram of a liquid crystal display, wherein a liquid crystal display 1 has a flat panel structure in which a liquid crystal layer is interposed between a group of row electrodes 2 and a group of column electrodes 3. A Super Twisted Nematic (STN) or a Twisted Nematic (NT) liquid crystal, by way of example, can be used as the liquid crystal layer.

A drive control means 6 is connected with a horizontal driver 4 in turn connected with the group of row electrodes 2 to drive them, and said drive control means 6 is also connected with a vertical driver 5 which is connected with the group of column electrodes 3 to drive them.

A voltage-level circuit 7 supplies a voltage level necessary for generating a column signal by means of the vertical driver 5, and it is to be noted that the voltage-level circuit 7 also supplies a voltage level for generating a row signal by means of the horizontal driver 4.

One of the early driving schemes, implemented by the drive control means 6, is the so called line-by-line addressing, wherein the rows 2 of the matrix display 1 are sequentially selected one at a time. In fact, a orthonormal function generating means 8 generates a plurality of orthonormal functions which are orthonormal to each other, and said orthonormal-function generating means 8 sequentially supplies said orthonormal functions in appropriate set patterns to the horizontal driver 4. Consequentially, the horizontal driver 4 applies a plurality of row signals represented by the sets of orthonormal functions to all the row electrodes 2 in a period T, also called scanning time.

Particularly, the horizontal driver 4 adequately selects a voltage level, provided by the voltage level circuit 7, in accordance to the orthonormal functions and supplies them to the group of row electrodes 2 as the row signal.

It is known that LCDs are slow devices, with response time in the range of a few tens to few hundred milliseconds. Hence the ratio of Root Mean Square (RMS) voltage across an ON pixel to that across an OFF pixel is important in determining the state of the pixel. The period T of the addressing waveforms is assumed to be small as compared to the response times of the LCD.

However in a large matrix display or in a display with fast response times, the period T may become comparable to the response time of the LCD. The conventional line by line addressing, therefore, is no longer suitable to drive such a display since the resulting contrast in the display is poor or low due to the frame response phenomenon.

In fact, the frame response in a line-by-line addressing technique is afflicted by the drawback that the energy from the row waveform is delivered by a single pulse, which is larger than the threshold voltage of the TN or STN liquid crystal layer. This results in turning even the OFF pixels partially ON causing in poor contrast.

One of the techniques proposed for suppressing frame response is active addressing technique, particularly the Multi Line Addressing (MLA) technique.

The MLA method simultaneously selects a plurality of row electrodes 2, and, according to this method, a display pattern in the column electrodes 3 can be independently be controlled by means of the period T, which can be shortened while maintaining the selection width constant. In fact, it is necessary to apply pulse voltages having different polarities to the row electrodes 2 to simultaneously and independently control the display pattern in the column direction, as shown in FIGS. 2a, 2b, 2c and FIGS. 3a, 3b.

Particularly, in FIG. 2a, it is possible to note a plurality r1, r2, . . . , rn-1, rn of wave forms for driving the row electrodes 2 of the liquid crystal display panel 1 and a horizontal axis representing the time subdivided into a plurality of intervals t0, t1, . . . , tn.

Said plurality r1, . . . , rn of wave forms represents the voltage levels in correspondence with respective column elements of the liquid crystal display panel 1.

In fact, as shown in FIG. 2b, the plurality of wave forms r1, . . . , r4 of row electrodes 2 represents a set of the entirety of the wave forms r1, . . . , rn. The series of column electrode voltages are determined by the sequence of ones and zeros of said plurality of wave forms r1, . . . , r4.

Referring now to the FIG. 2c, indicating the plurality of wave forms r1, . . . , r4 of FIG. 2b as R1, a picture of a matrix corresponding to the wave forms r1, . . . , r4 is shown.

FIG. 3a shows two sets 9 and 10 of a non-distributed wave forms, respectively, r1, . . . , r4 and r5, . . . , r8 of row electrodes 2, wherein it is to be noted that the wave forms of the first set 9 are the same in the second set 10, with the shifting of the wave forms in time between the two steps 9 and 10.

FIG. 3b shows two sets 11 and 12 of a distributed wave forms, respectively, r1, . . . , r4 and r5, . . . , r8 of row electrodes 2.

The technique described in FIGS. 2a, 2b 2c, 3a, and 3b is well known.

It has also been proposed to use a Frame Rate Control (FRC) in a gray scale of the multiple-line simultaneous selection method. FRC is a system in which the pixels ON and OFF are dispersed among a plurality of frames and the gray scale is expressed by the average brightness, as shown in FIG. 4.

As shown in FIG. 4, many frames are required for a multiple gray scale information. By way of example, seven frames F1, F2, . . . , F7 are required in FRC for codifying the gray scales because three memory bits for each pixel are needed to codify the eight gray levels, wherein, particularly, the first four frames, that is F1, F2, F3, and F4, codify the most significant bit (MSB), the fifth and sixth frames, that is F5 and F6, codify the medium significant bit (mSB) and the seventh frame, that is F7, codifies the least significant bit (LSB), according to the FIG. 4a. In FIG. 4a the table 13 shows the possible value of data stored in a read access memory (RAM) for each pixel of the flat display 1 are shown.

In fact in the table 13 of FIG. 4a, there is the codification of each pixel according to the gray scale in object. In fact, the codification foresees a pixel completely white in the case of the MSB, mSB and LSB bits are equal to zero (indicated as 14 in the FIG. 4a) whereas said codification foresees a pixel completely black in the case of the MSB, mSB and LSB bits being equal to one (indicated as 15 in the FIG. 4a), and the gradation of the other levels of gray are a combination of said MSB, mSB and LSB bits, indicated as “g1”, . . . , “g6” in the FIG. 4a.

By way of example, the first frame F1, as magnified in the FIG. 4b, represents symbolically the sequence of four scanning steps over all the row electrodes, each one based on a different row pattern (four columns of matrix R1 of FIG. 2c) as represented in FIG. 3b.

It is to be noted that the maximum time distance among the frames wherein the value of the said memory RAM is evaluated in the case of the LSB is of six frames, in the case of the mSB is of five frames and in the case of the MSB is of three frames. Such a time distance produces a phenomenon called flickering.

Therefore, the display time period is prolonged and flicker is generated when the multiple-line-simultaneous-selection method is simply combined with the frame rate control method.

In order to solve such a problem, a plurality of solutions have been proposed, such as the solution wherein the MSB, mSB and LSB bits in a frame are evaluated in a way where they are the most equidistant to each other inside the same plurality of frames, as shown in FIG. 5.

However, the flat display panel 1 still suffers from remarkable flickering due to the high number of frames and, moreover, to visualize the gray indicated as “g1” in the box 13 according to the above method the LSB memory would be repeatedly evaluated with a time distance of six frames.

Other MLA and FRC techniques were jointly proposed, such as in the U.S. Pat. No. 5,774,101, U.S. Pat. No. 5,185,602, or U.S. Pat. No. 5,122,783, so as to reduce the flickering in the flat display using gray levels. These U.S. patents are incorporated by reference.

Particularly, in U.S. Pat. No. 5,774,101, a method of driving an image-display device including the steps of performing a space-modulation by shifting a phase of the FRC with a pixel block comprising a plurality of pixels as a unit, so as to reorganize the row pattern applied to the various sequences inside a frame, which remains unaltered, are described.

U.S. Pat. No. 5,122,783 and in U.S. Pat. No. 5,185,602 describe a frame-rate-duty-cycle technique and dithering technique in order to drive various flat panel displays, wherein the brightness-setting signals having one brightness level associated with them are phase shifted in relation to time and distributed to spaced-apart pixel locations having the one brightness.

### SUMMARY

In view of the state of the art described, an embodiment of the invention prevents the drawbacks of the prior art.

This embodiment of the present invention drives an image-display device by performing the following steps: dividing the row electrodes of an image device, having a plurality of row electrodes and a plurality of column electrodes, into a plurality of subgroups; selecting one of the plurality of said subgroups having a predetermined number of electrodes; performing a gray scale display by a frame-rate control (FRC) by using a predetermined number of frames and a predetermined number of bits representing the gray levels; decomposing one of said frames in a number of time instants proportional to said predetermined number of electrodes; putting the bits representing the gray levels equally distributed in said predetermined number of frames.

Preferably, this embodiment is characterized by putting the bits representing the gray levels at a distance equal to 2^{b}, where b is the bit position representing the gray levels.

Further, one of said frames is decomposed into a number of time instants equal to said predetermined number of electrodes.

Preferably, this embodiment also utilizes a number of time instants equal to said predetermined number of frames multiplied by said predetermined number of electrodes.

It is advantageous to put the bits representing the gray levels at a distance equal to 2^{b} is starting from the most significant bit of the bits representing the gray levels.

Preferably, the step of putting the bits representing the gray levels at a distance equal to 2^{b} is starting from the first free position in said frames.

Therefore, this embodiment is able to obtain gray levels with reduced flickering.

### BRIEF DESCRIPTION OF THE DRAWINGS

The features and the advantages of the present invention will be made evident by the following detailed description of an embodiment thereof, which is illustrated as not limiting example in the annexed drawings, wherein:

FIG. 1 shows a schematic block diagram of a liquid crystal display according to the prior art;

FIGS. 2a, 2b and 2c show a conceptual diagrams and wave-form diagrams explaining multiple-line-simultaneous-selection addressing according to the prior art;

FIG. 3a shows conceptual diagrams and wave form diagrams explaining the complementary distributed-addressing-multiple-line-simultaneous selection according to the prior art;

FIG. 3b shows conceptual diagrams and wave form diagrams explaining the distributed-addressing-multiple-line-simultaneous selection according to the prior art;

FIG. 4 shows an explanatory waveform for a multiple gray scale formation in a frame-rate-control (FRC) procedure according to the prior art;

FIG. 4a shows an explanatory codification table of the gray levels in a frame-rate-control (FRC) procedure according to the prior art;

FIG. 4b shows a magnified portion of the waveform of FIG. 4;

FIG. 5 shows another explanatory waveform for multiple gray-scale information in a frame-rate control (FRC) procedure according to the prior art;

FIG. 6 shows the generation of multiple gray-scale information in a frame-rate-control (FRC) procedure according to an embodiment of the present invention;

FIG. 7 shows the waveform for multiple gray-scale information in a frame-rate-control (FRC) procedure according to an embodiment of the present invention;

FIG. 8 shows a conceptual diagrams and wave form diagrams according to an embodiment of the invention.

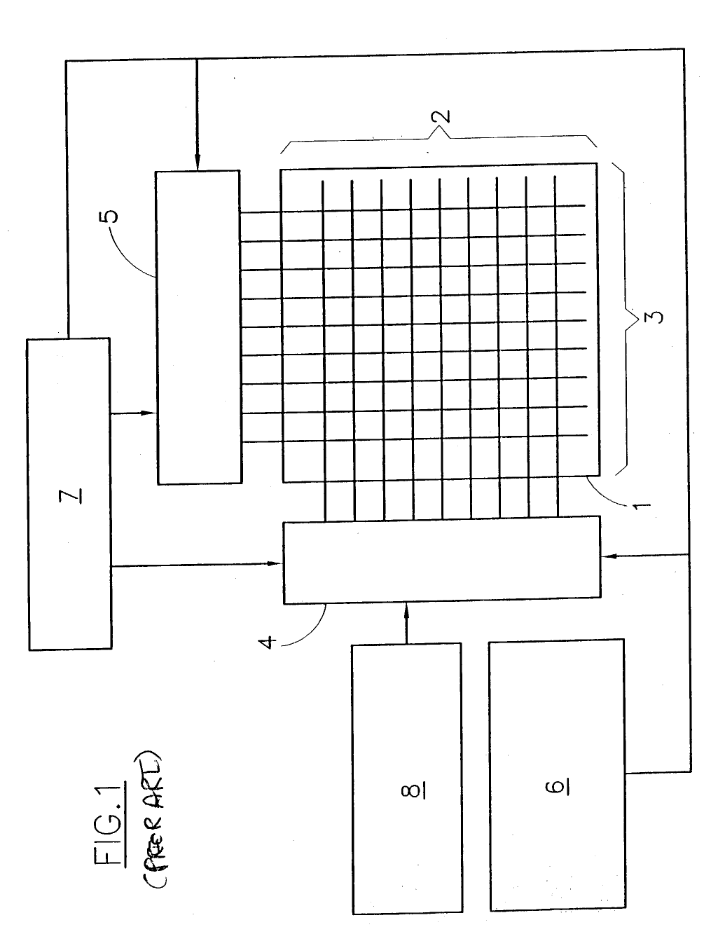

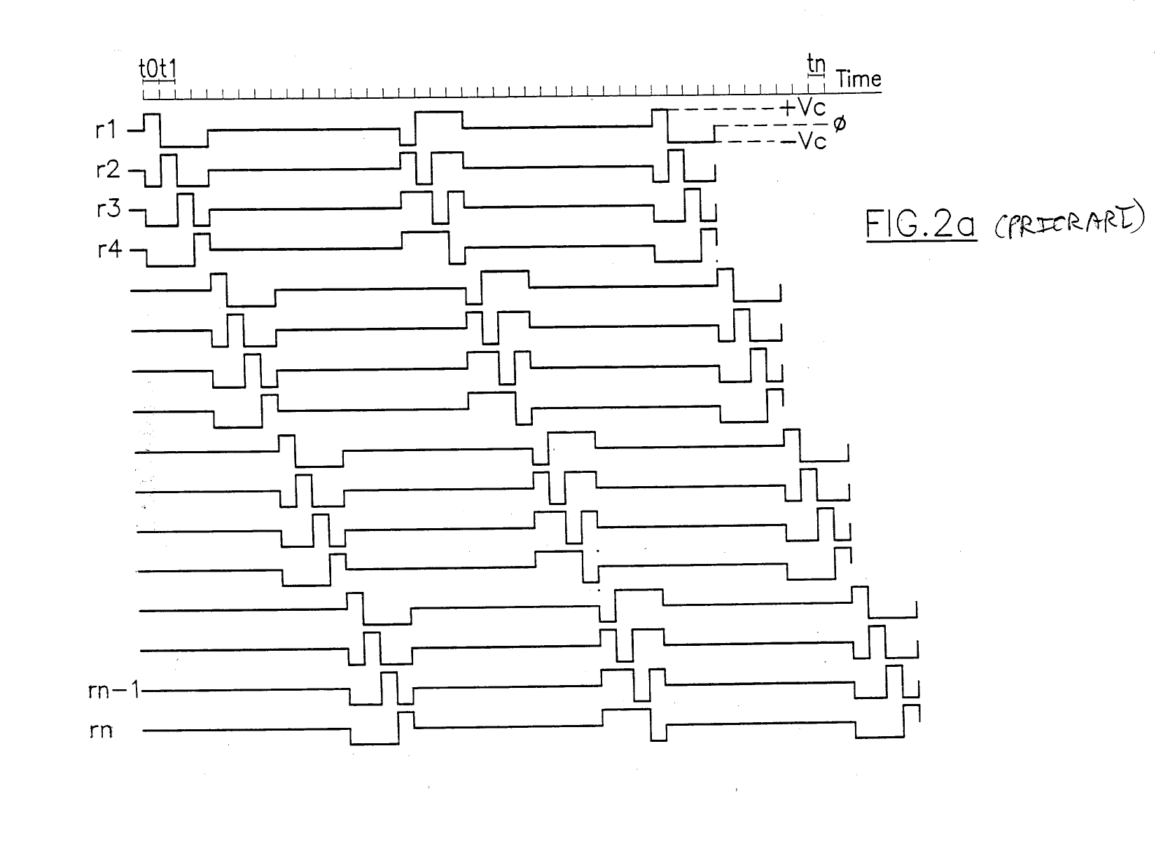

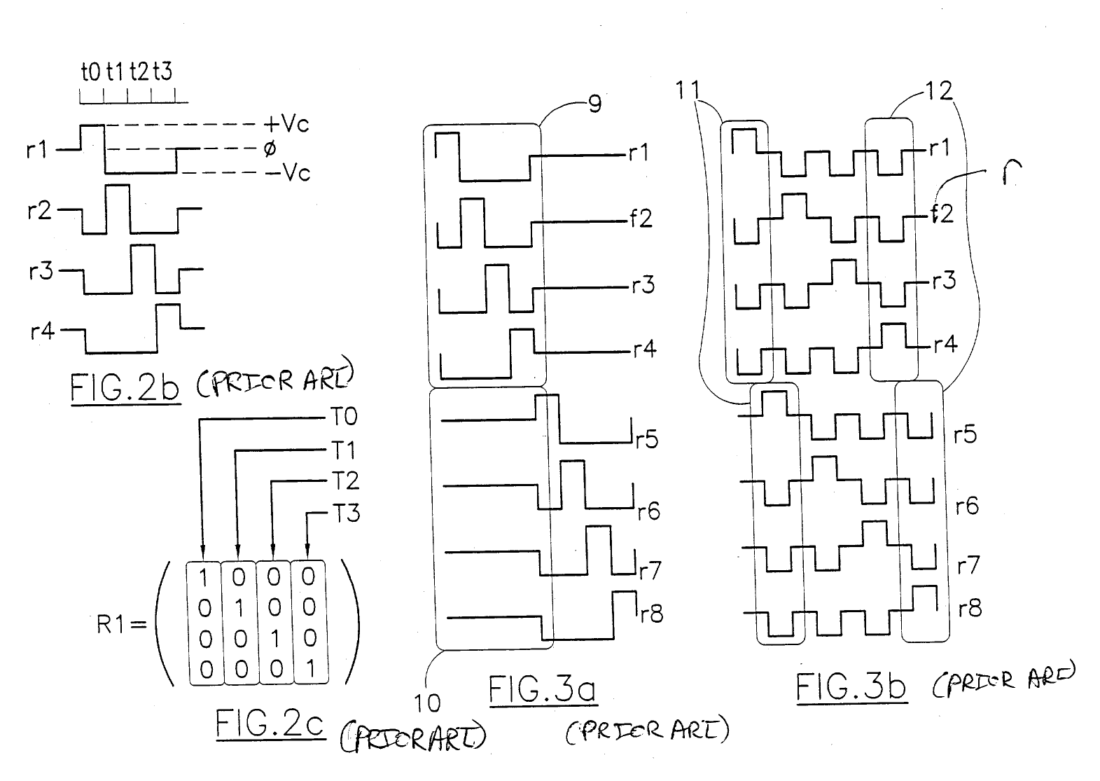

### DETAILED DESCRIPTION

In the hereinafter description the frame isn't to be considered as the period wherein the addressing operation of the rows ends the visualization of a well-defined pattern relating to a particular codified bit of the gray level, but the frame is to be considered as a specific image in gray scales that is completed when the following conditions are satisfied:

a) all pluralities of the electrodes have been selected;

b) each of said plurality of electrodes has been selected inside the plurality of pre-chosen frames for every sub groups of the chosen orthonormal matrix;

c) for each sub group of the matrix the codified bits of the gray level evaluated in a specific manner.

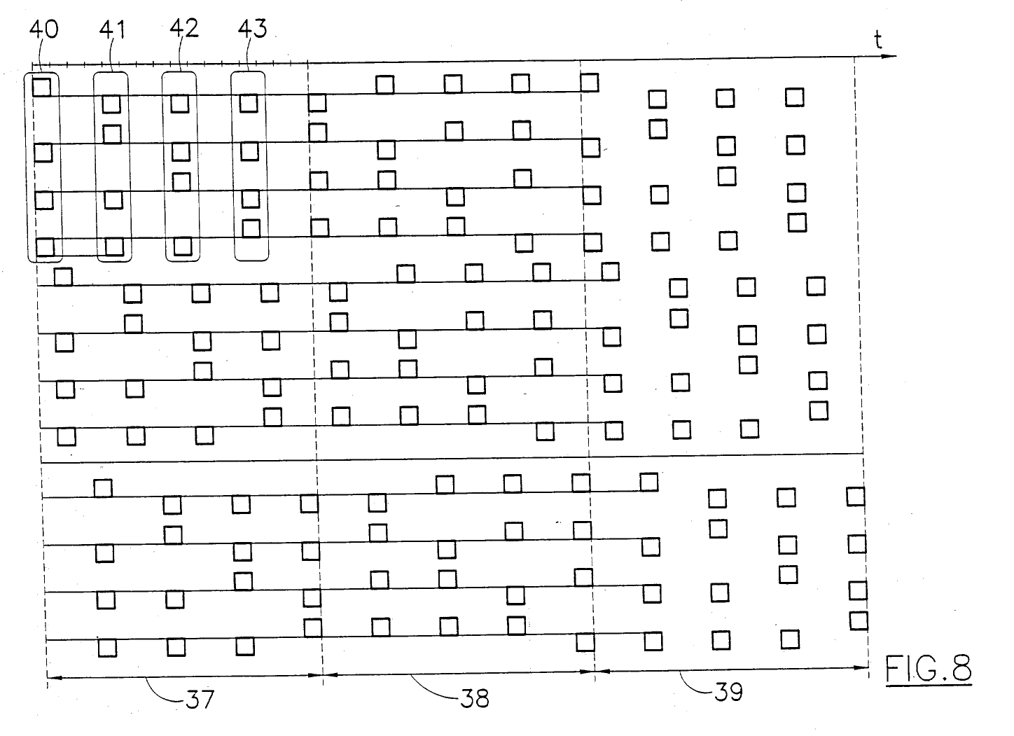

In fact, referring to the FIG. 8, wherein a time axis “t”, a plurality of frames 37, 38, and 39, and a plurality of instants t(i) indicated as 40, . . . , 43, forming a subgroup of the entirety of the orthonormal matrix, are shown, and it has been demonstrated that said subgroup 40, . . . , 43, by means of which it is possible to drive each plurality of rows of the flat panel display, can be distributed in the time without loosing the orthonormal condition of the wave forms that are able to drive the row electrodes.

An embodiment of the present invention uses a driving method, hereinafter described in detail, of the row electrodes of a flat display adopting jointly an MLA technique and an FRC technique that allows one to distribute in the time each subgroup of the orthonormal matrix of MLA.

In fact, by opportunely distributing each subgroup 40, . . . , 43 of selected rows of the flat panel display to evaluate the corresponding bit stored in the RAM memory inside the frame plurality, it is possible to obtain the minimum time distance that elapses among successive instants during which the MSB bit or the LSB bit or the mSB bit is evaluated.

In FIG. 6 the generation of the multiple gray scale information in a frame rate control (FRC) procedure, according to an embodiment of the present invention, is shown.

In fact, FIG. 6 shows an embodiment of the application of the method, in the case of sixteen gray levels, indicated as Ng=16 that corresponds to fifteen frame-rate control, indicated as 15 FRC, and a group “p” of four multi line addressing, that is MLA-, indicated as “p=4”, is shown.

It is possible to deduce from FIG. 6 that there are four stripes 21, 22, 23 and 24 indicating the evolution of the sixteen gray levels.

The method according to this embodiment foresees the generation of a fundamental sub sequence Nf and a second step of repeating the fundamental sub sequence Nf for a number of times until overlapping a time window equal to the time length of the initial number of frames in the fundamental sub sequence Nf.

Particularly, it allows decomposition of the frame stripe 21 into a number of sub instants of time equal to the number of contemporary selected rows, that is in the case of FIG. 6 equal to four (MLA-4, because p=4). In this way the decomposition of the frame makes free inside the Nf frames wherein the FRC procedure is applied a total number of sub instants of time equal to:

num=Nf*p

The equation states that the process of decomposition and reorganization allows a number “num”, of sub instants equal to “Nf*p”, and therefore by finding a specific sequence of exactly Nf instants and by replaying it “p” times, it is possible to obtain a window of Nf frames.

In order to achieve this goal, the sequence of sub instants Nf is deduced by putting to the minimum distance among each pair of pulses relating to the MSB, starting from the first free position on the left of the sub instants Nf. In the case of binary codification of the grays, that is with the bit “n” having a double weight with respect to the bit “n−1”, if Ng is the number of gray shades to be displayed (usually defined as a power of 2) and

Nb=log₂(Ng)

is the number of bits required to code these shades, then the minimum distance between adjacent pulses, that is the maximum equi-spacing, is deduced by spacing said pulses of:

max₁=Ng/(2\mathring{}Nb−1)=2

Next, by putting to the minimum distance among each pair of pulses relating to the “MSB-1”, starting from the first free position on the left of the sub instants Nf. In the case of binary codification of the grays, that is with the bit “n” having a double weight with respect to the bit “n−1”, if Ng is number of gray shades to be displayed and

Nb=log₂ (Ng)

is the number of bit required to code these shades, then the minimum distance between adjacent pulses, that is the maximum equi-spacing, is deduced by spacing said pulses of:

max₂=Ng/(2\mathring{}Nb−2)=2\mathring{}2=4

so as to calculate the maximum equi-spacing between adjacent pulses.

By iterating the process for the other bits, and therefore by putting to the minimum distance among each pair of pulses relating to the “MSB-x”, where “x” is the generic position of the bit, it results that:

maxₓ=Ng/(2\mathring{}Nb−x)=2\mathring{}x

Next, by putting to the minimum distance among each pair of pulses relating to the “LSB+1”, starting from the first free position on the left of the sub instants Nf.

Finally, by putting in the last free position the pulse relating to the LSB bit of the sub instants Nf.

The procedure foresees the repetition of the fundamental sub-sequence for “p” times during a window equal to the length of time of the initial Nf frames. There the sub-sequence repeats for another identical time window.

The method according to this embodiment heretofore described referring to the specific case of MLA-4, that is “p=4” or similarly by selecting four lines simultaneously, and with sixteen gray levels, that fifteen FRC, can be immediately extended to an arbitrary number of frames, for every spacing of grays and for whichever number of rows selected simultaneously, that is MLA-2, or MLA-4, or “MLA-z”, wherein “z” is a generic number.

In FIG. 7, there is another embodiment of the present inventive procedure wherein many frames are required for multiple gray scale information.

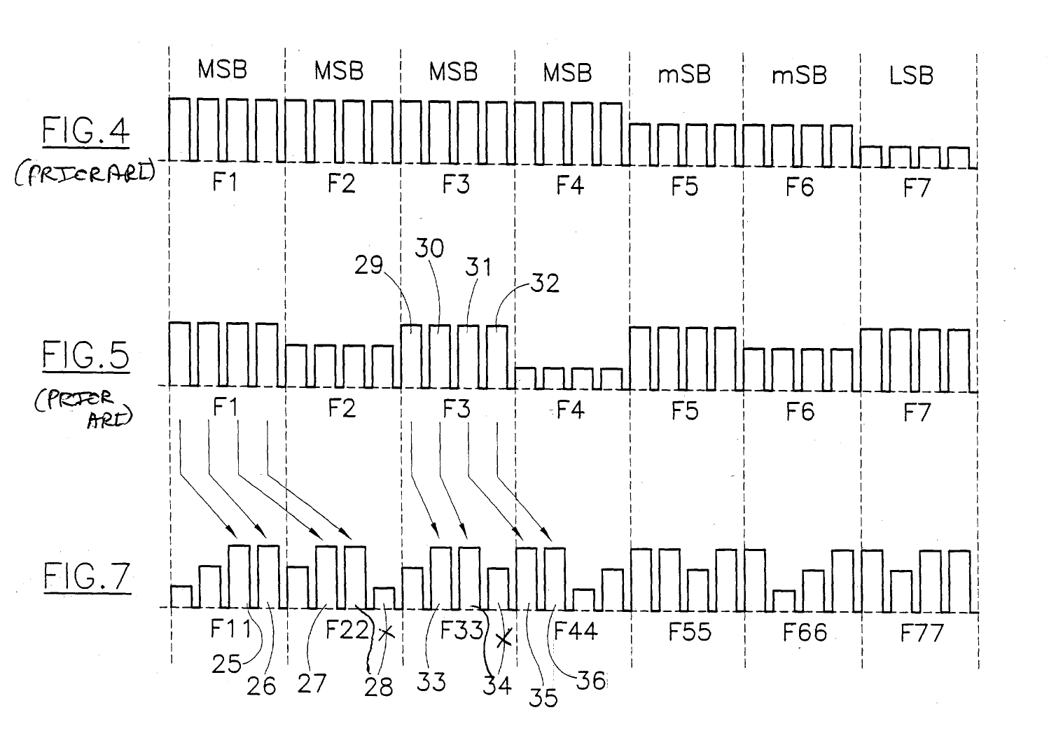

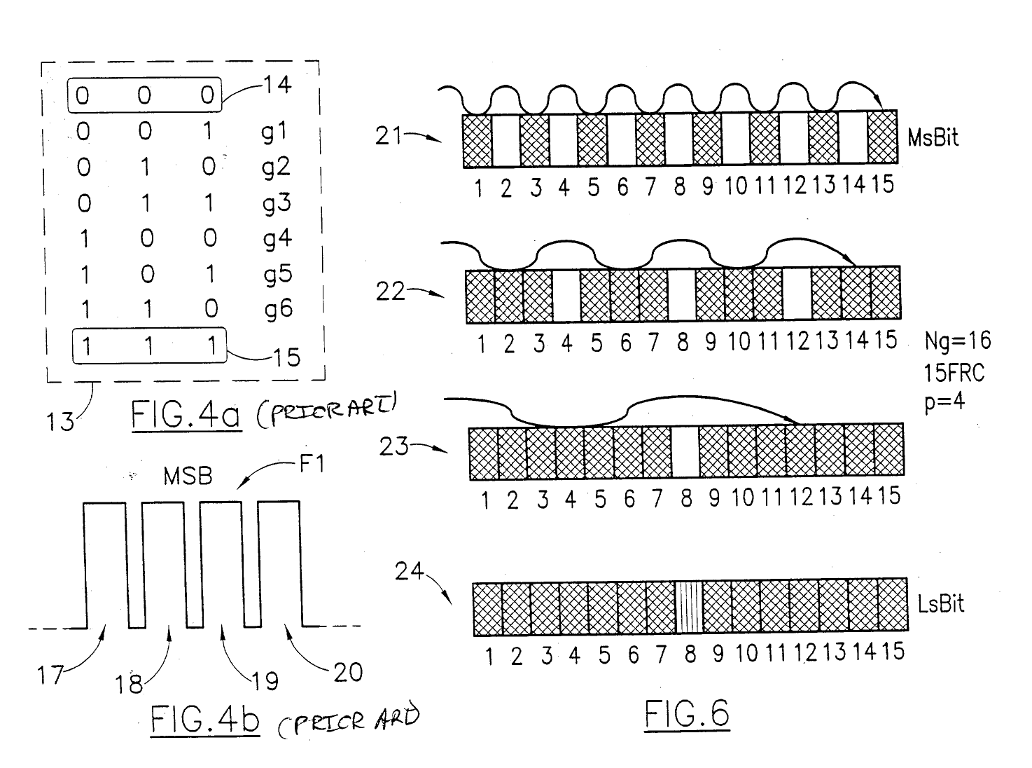

By using the heretofore described procedure starting from the sequence of gray scale as depicted in the FIGS. 4b and 5, it is possible to observe which kind of result is obtained with respect to the FIG. 7.

In fact by using said inventive driving method for eight gray levels and MLA-4, as depicted in FIG. 7, and by way of example, using this driving method for an LCD panel codified as completely light gray “g2”, wherein “g2” states that the MSB bit is zero, the mSB bit is zero and the LSB bit is one, as depicted in the table 13 of FIG. 4a, the LSB memory is evaluated in only four frames contrary to the prior-art techniques.

Particularly, as shown in FIG. 7, there are seven frames F11, F22, . . . , F77 that are required by the FRC procedure for codifying the gray scales, and it is possible to note as the pulses 17, 18, 19 and 20 of the frame F1 of FIG. 4b are shifted respectively in the pulses 25, 26, 27 and 28 of the frames F11 and F22 of the FIG. 7.

The frame F2 of the FIG. 5 doesn't need the inventive method in view of the condition exposed at the start of the description.

The frame F3 of the FIG. 5, having a similar composition of the pulse with respect of the frame F1 of the same FIG. 5, that is composed by four pulses 29, 30, 31 and 32, by applying this embodiment of the invention it results shifted in the respective pulses 33 and 34 of the frame F33 and in the respective pulses 35 and 36 of the frame F44.

Thanks to this driving method the maximum time distance among the frame wherein it is evaluated the LSB memory is only of a frame period contrary to the known embodiment depicted in FIG. 4, that is of six frames.

In this way the flat panel display has a reduced flicker and a better stability of the displayed image.

In other words, the frame is no more considered in its entirety but the number of portions “x”, that is the number of portions in which the “MLA-x” technique has divided the frame, according to FIG. 8, has minimize the distance that elapses between two adjacent pulses both of the LSB bit and in the other bits.

An image-display device that incorporates the above-described techniques can itself be incorporated into an image system such as a television or computer display screen.

From the foregoing it will be appreciated that, although specific embodiments of the invention have been described herein for purposes of illustration, various modifications may be made without deviating from the spirit and scope of the invention.

What is claimed is:

1. Method of driving an image display device comprising the following steps:
dividing row electrodes of an image device, having a plurality of row electrodes and a plurality of column electrodes, into a plurality of subgroups;
selecting one of the plurality of said subgroups having a prefixed number of electrodes;
performing a gray scale display by a frame rate control (FRC) by using a prefixed number of frames and a prefixed number of bits representing the gray levels;
decomposing one of said frame in a number of time instants proportional to said prefixed number of electrodes;
putting the bits representing the gray levels equally distributed in said prefixed number of frames.

2. Method of driving an image display device according to claim 1 characterized by putting the bits representing the gray levels at a distance equal to the power base two of the bit position representing the gray levels.

3. Method of driving an image display device according to claim 1 characterized by decomposing one of said frame in a number of time instants equal to said prefixed number of electrodes.

4. Method of driving an image display device according to claim 1 characterized by considering a number of time instants equal to said prefixed number of frames multiplied for said prefixed number of electrodes.

5. Method of driving an image display device according to claim 1 characterized in that the step of putting the bits representing the gray levels at a distance equal to the power base two of the bit position representing the gray levels is starting from the most significant bit of the bits representing the gray levels.

6. Method of driving an image display device according to claim 1 characterized in that the step of putting the bits representing the gray levels at a distance equal to the power base two of the bit position representing the gray levels is starting from the first free position in said frames.

7. An image-display apparatus, comprising:
a display screen having pixels located in first and second sectors, each pixel having a multi-bit brightness level; and
a pixel driver coupled to the display screen and operable during a first frame of an image to
activate in the first sector only pixels having a brightness level with a one in a first bit place, and
activate in the second sector only pixels having a brightness level with a one in a second bit place.

8. The image-display apparatus of claim 7 wherein the pixel driver is further operable during a second frame of the image to:
activate in the first sector only pixels having a brightness level with a one in the second bit place, and
activate in the second sector only pixels having a brightness level with a one in the first bit place.

9. The image-display apparatus of claim 7, further comprising:
wherein the pixels of the first and second sectors are arranged in rows and columns;
row lines each coupled to the pixels in a respective row;
column lines each coupled to the pixels in a respective column; and
wherein the pixel driver is operable to drive the pixels via the row and column lines.

10. The image-display apparatus of claim 7 wherein: the first bit place comprises the 0^{th}-power bit place; and the second bit place comprises the 1^{st}-power bit place.

11. The image-display apparatus of claim 7 wherein: the first bit place comprises the 1^{st}-power bit place; and the second bit place comprises the 0^{th}-power bit place.

12. An image system, comprising:
an image-display apparatus including,
a display screen having pixels located in first and second sectors, each pixel having a multi-bit brightness level; and
a pixel driver coupled to the display screen and operable during a first frame of an image to
activate in the first sector only pixels having a brightness level with a one in a first bit place, and
activate in the second sector only pixels having a brightness level with a one in a second bit place.

13. A method, comprising:
activating in a first sector of a display during a first frame of an image only pixels having a brightness level with a one in a first bit place; and
activating in a second sector of the display during the first frame only pixels having a brightness level with a one in a second bit place.

14. The method of claim 13, further comprising:
activating in the first sector during a second frame of the image only pixels having a brightness level with a one in the second bit place; and
activating in the second sector during the second frame only pixels having a brightness level with a one in the first bit place.

15. A method, comprising:
activating in a respective sector of a display at least every F/2^{b} sub-frame of an image only pixels having a brightness level with a one in a b^{th}-order bit place, where F is the number of frames that compose the image; and
activating in a respective sector of a display at least every F/2^{b+1}+1 sub-frame only pixels having a brightness level with a one in a (b+1)-order bit place.

16. The method of claim 15, further comprising activating in a respective sector of a display at least every F/2^{b+2}+2 sub-frame only pixels having a brightness level with a one in a (b+2)-order bit place.

17. The method of claim 15, further comprising:
activating in a respective sector of a display at least every F/2^{b+2}+2 sub-frame only pixels having a brightness level with a one in a (b+2)-order bit place; and
activating in a respective sector of a display at least every F/2^{b+3}+3 sub-frame only pixels having a brightness level with a one in a (b+3)-order bit place.

18. The method of claim 15 wherein:
b=0; and
F=7.

19. The method of claim 15 wherein:
b=0;
F=7; and
each frame F includes four sub-frames.

20. The method of claim 15 wherein:
b=0;
F=7;
each frame F includes four sub-frames; and
the display includes four sectors.
